(19) United States
(12) Patent Application Publication
(10) Pub. No.: US 2016/0349770 A1
(43) Pub. Date: Dec. 1, 2016

(54) BY-PASS VALVE

(71) Applicant: Dana Canada Corporation, Oakville (CA)

(72) Inventor: Jeff Sheppard, Milton (CA)

(21) Appl. No.: 15/166,506

(22) Filed: May 27, 2016

Related U.S. Application Data
(60) Provisional application No. 62/168,350, filed on May 29, 2015.

(51) Int. Cl. G05D 23/185; F01P 7/16; F16K 1/36; F16K 31/00; F16K 1/12

(52) U.S. Cl. CPC G05D 23/1852; F16K 31/002; F16K 1/12; F16K 1/36; F01P 7/16

(57) ABSTRACT

A by-pass valve capable of activating a two different temperatures is disclosed. The valve has a first bore in fluid communication with a fluid inlet and a second bore having a first end in fluid communication with a first outlet and a second end in fluid communication with a second outlet. First and second branch ports interconnect the first bore and the first end of the second bore and the first bore and the second end of the second bore, respectively. A first valve mechanism is arranged in the first bore for controlling fluid flow to said first branch port and is operable at a first activation temperature. A second valve mechanism is arranged in the second bore for controlling flow to the second outlet and is operable a second activation temperature that is different than said first activation temperature, the first and second valve mechanism operating in series to provide three different operational states.

### CROSS-REFERENCE TO RELATED APPLICATION

This application claims priority to and the benefit of United States Provisional Patent Application No. 62/168,350 filed May 29, 2015, the contents of which are incorporated herein by reference.

### TECHNICAL FIELD

The specification relates to a valve, in particular a thermal by-pass valve that can be actuated at two different temperatures providing multiple operational states.

### BACKGROUND

The use of valves to control the flow of a fluid within an overall heat exchange circuit within an automobile system is known. Control valves or thermal by-pass valves (TBV) are often used in combination with heat exchangers to either direct a fluid to a corresponding heat exchanger for heating or cooling, or to direct the fluid elsewhere in the heat exchange circuit so as to by-pass the heat exchanger under conditions where the heat transfer function of the heat exchanger is not required or is only intermittently required. Control valves or thermal by-pass valves are also often used in automobile systems to sense the temperature of a particular fluid so as to either direct it to an appropriate heat exchanger in order to assist with either (i) maintaining an automobile system fluid within an optimal temperature range or (ii) bringing the temperature of the automobile fluid to within the optimal operating range, for example.

Control valves or thermal by-pass valves are often incorporated into a heat exchange system by way of external fluid lines that are, in turn, connected to an inlet/outlet of a heat exchanger, the control valves being separate to the heat exchanger and being connected either upstream or downstream from the heat exchanger within the external fluid lines. In some applications, multiple control valves or thermal by-pass valves are used in combination in order to achieve a particular control sequence to effectively dictate the fluid flow through the overall heat exchange circuit to ensure that the fluid is directed to the appropriate heat exchanger or automobile system component under the various operating conditions.

Combining and interconnecting various individual valves can add to the overall costs associated with the automobile system and can also give rise to multiple potential points of failure and/or leakage. Space and or size constraints for a particular system may also be hindered by requiring multiple individual valves that act in combination in order to achieve a desired operation or control sequence. Accordingly, a single by-pass valve capable of providing multiple operational states and responding to various operating conditions by actuating at a first predetermined temperature and again at a second, different predetermined temperature, for example, may contribute to overall cost savings, space savings, weight savings and/or operational efficiencies and are, therefore, desirable.

### SUMMARY OF THE PRESENT DISCLOSURE

In accordance with an exemplary embodiment of the present disclosure there is provided a by-pass valve, comprising a main body; a first bore formed in said main body, the first bore having a first end and a second end; a second bore formed in said main body that is spaced apart from and extends generally parallel to said first bore, the second bore having a first end and a second end; a fluid inlet in fluid communication with said first bore; a first fluid outlet in communication with the first end of said second bore; a second fluid outlet in communication with the second end of said second bore; a first branch port fluidly interconnecting said first bore and said first end of said second bore; a second branch port fluidly interconnecting said first bore and said second end of said second bore; a first valve mechanism arranged in said first bore for controlling flow to either said first branch port or said second branch port; and a second valve mechanism arranged in said second bore for controlling flow from either said first branch port or said second branch port to either said first outlet or said second outlet; wherein said first valve mechanism activates at a first predetermined activation temperature and said second valve mechanism activates at a second predetermined activation temperature.

### BRIEF DESCRIPTION OF THE DRAWINGS

Reference will now be made, by way of example, to the accompanying drawings which show example embodiments of the present application, and in which:

FIG. 1 is a schematic, cross-sectional view of an example embodiment of a by-pass valve according to the present disclosure in a first operational state;

FIG. 2 is a cross-sectional view of the by-pass valve of FIG. 1 in a second operational state;

FIG. 3 is a cross-sectional view of the by-pass valve of FIG. 1 in a third operational state;

FIG. 4 is an elevation view of a valve mechanism used in the by-pass valve of FIGS. 1-3;

FIG. 5 is a perspective view of an exemplary valve closure cap used in association with the first valve mechanism of the by-pass valve of FIGS. 1-3;

FIG. 6 is a perspective view of an exemplary valve closure cap used in association with the second valve mechanism of the by-pass valve of FIGS. 1-3; and

FIG. 7 is a schematic system diagram illustrating how the by-pass valve may be incorporated into an automobile system fluid circuit.

Similar reference numerals may have been used in different figures to denote similar components.

### DESCRIPTION OF EXAMPLE EMBODIMENTS

Reference will now be made in detail to exemplary implementations of the technology. The example embodiments are provided by way of explanation of the technology only and not as a limitation of the technology. It will be apparent to those skilled in the art that various modifications and variations can be made in the present technology. Thus, it is intended that the present technology cover such modifications and variations that come within the scope of the present technology.

Although terms such as “top”, “bottom”, “upper”, “lower”, “left”, “right”, “upwardly”, “downwardly”, etc. may used throughout the description and claims, these terms are used for convenience only. It should not be inferred that the use of any of these terms requires any of the by-pass valves described herein to have a specific orientation in use.

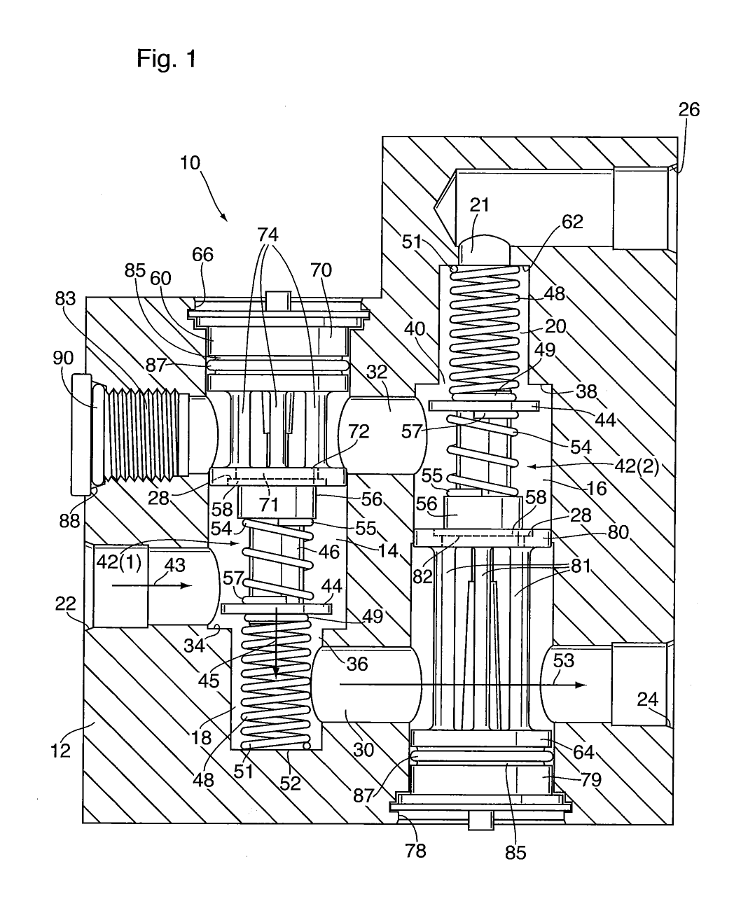

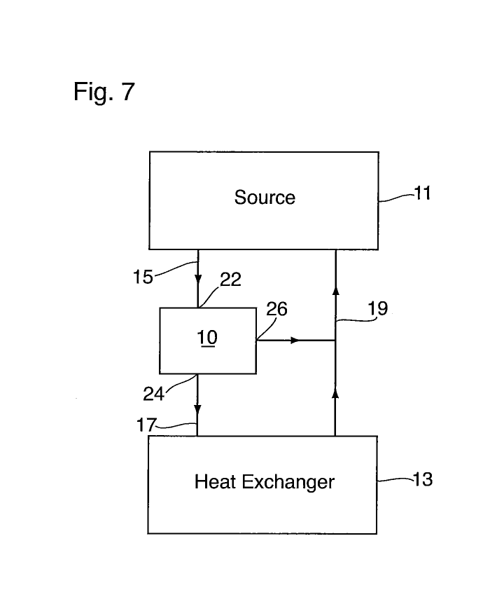

Referring now to FIGS. 1-3 there is shown an exemplary embodiment of a by-pass valve 10 according to the present disclosure. In the subject exemplary embodiment, by-pass valve 10 is intended to be fluidly connected to at least one heat exchanger and may serve to direct fluid from a fluid source to the at least one heat exchanger for warming or cooling, depending upon the particular operating conditions, or direct the fluid elsewhere in the overall heat exchanger circuit so as to by-pass the heat exchanger under certain operating conditions. A schematic diagram illustrating how the by-pass valve 10 may be incorporated into a heat exchange circuit within an automobile system is shown, for instance, in FIG. 7. As shown in the exemplary embodiment illustrated in FIG. 7, the by-pass valve 10 is arranged intermediate a fluid source 11 (e.g. engine, transmission, etc.) and a heat exchanger 13 with the by-pass valve 10 being fluidly coupled to a fluid outlet 15 on the fluid source and a fluid inlet 17 on the heat exchanger 13. The by-pass valve 10 is also fluidly coupled to a return line 19 for directing fluid away from the heat exchanger 13 and returning the fluid to the fluid source 11 (or potentially elsewhere in the overall fluid circuit) via the return line 19.

By-pass valve 10 has a main body 12 (also referred to herein as the “housing 12”) with a first bore 14 and a second bore 16 formed therein. The first and second bores 14, 16 are arranged side-by-side and spaced apart from each other within the main body 12 and extend generally parallel to each other. A first bore extension 18 having a smaller cross-sectional flow area than the first bore 14 extends coaxially from and in serial, fluid communication with the first bore 14. Similarly, a second bore extension 20 having a smaller cross-sectional flow area than said second bore 16 extends coaxially from and in serial, fluid communication with the second bore 16, the first and second bore extensions 18, 20 being oppositely disposed with respect to each other within the main body 12, i.e. with the valve 10 in the orientation shown in FIGS. 1-3, the first bore extension 18 extends downwardly from the lower end of the first bore 14, and the second bore extension 20 extends upwardly from the upper end of the second bore 16.

The main body 12 defines three main fluid ports or openings 22, 24, 26 that extend into the main body 12. The first fluid port 22 (also referred to herein as “inlet port 22” or “first fluid inlet”) communicates with the first bore 14 and, in the subject example embodiment, functions as a fluid inlet port for inletting a control fluid into the by-pass valve 10. The control fluid may for example comprise an engine coolant such as glycol, water, or a mixture thereof. Second fluid port 24 (also referred to herein as “first outlet port 24” or “first fluid outlet”) communicates with the second bore 16 and, in the subject exemplary embodiment, functions as a first outlet port. Third fluid port 26 (also referred to herein as “second outlet port 26” or “second fluid outlet”) communicates with the second bore extension 20 and, in the subject exemplary embodiment, functions as a second outlet port. In the subject exemplary embodiment, a further extension bore 21 having a smaller cross-sectional flow area than the second bore extension 20 extends coaxially from and in serial, fluid communication with the second bore extension 20 and forms a junction with third fluid port 26 thereby fluidly interconnecting the second bore extension 20 and the third fluid port 26. However, it will be understood that in other embodiments that the second bore extension 20 may be connected directly to the third fluid port 26 and that other arrangements are possible.

Fluid ports 22, 24, 26 may be internally threaded for receiving a corresponding threaded end of a corresponding fluid line or fluid fitting in order to interconnect the by-pass valve 10 within the overall fluid or heat exchange circuit. Alternatively, the by-pass valve 10 could be connected within an overall heat exchange circuit or automobile system using other methods, including for example molding fluid ports 22, 24, 26 around corresponding fluid conduits or fittings, or brazing or welding the ends of fluid conduits or fittings inside the fluid ports 22, 24, 26.

A first branch port 30 is formed within the main body 12 and fluidly interconnects the first bore extension 18 and the second bore 16 at one end thereof, the first branch port 30 being arranged generally in-line with and/or coaxial to second fluid port 24. Accordingly, for manufacturing purposes, the second fluid port 24 and the first branch port 30 may be formed by a single bore that extends through the main body 12 through the second bore 16. A second branch port 32 is also formed within the main body portion 12, the second branch port 32 extends generally parallel to and spaced apart from the first branch port 30 and fluidly interconnects the first bore 14 and the second bore 16 at the other end thereof as compared to the first branch port 30.

A first peripheral valve seat 34 is formed at the transition or junction between the first bore 14 and the first bore extension 18. In the illustrated embodiment, first valve seat 34 faces first bore 14 and is in the form of an annular shoulder formed about first valve opening 36. A second peripheral valve seat 38 is formed at the transition or junction between the second bore 16 and the second bore extension 20. In the illustrated embodiment, second valve seat 38 faces the second bore 16 and is in the form of an annular shoulder that surrounds second valve opening 40.

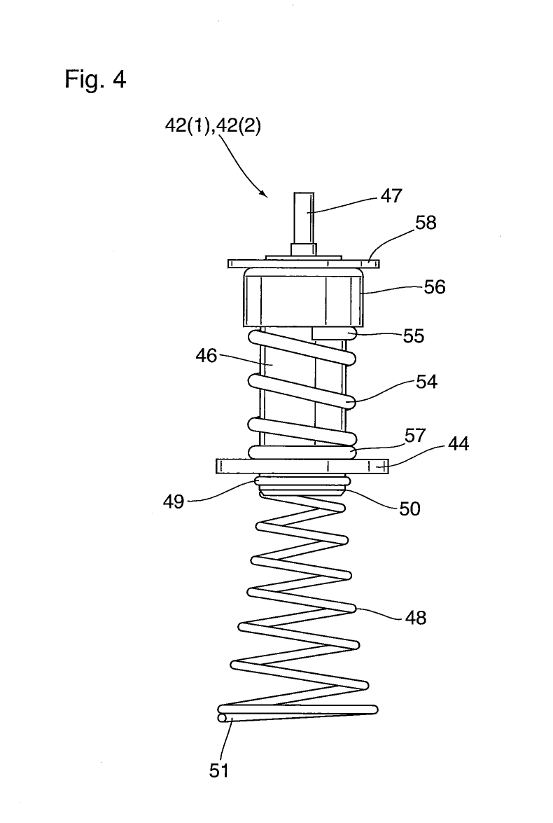

A temperature responsive valve actuator or first valve mechanism 42(1) is arranged inside the first bore 14 and is operably coupled to a valve disk 44 so as to move valve disk 44 towards and away from the valve seat 34 thereby closing and opening valve opening 36. The valve actuator or valve mechanism 42, as illustrated in FIG. 4, is sometimes referred to as a thermal motor and generally has a piston-cylinder arrangement wherein a cylinder 46 is filled with a thermally sensitive material, such as a wax, that expands and contracts causing a piston 47 to extend axially out of the cylinder 46 when the thermally sensitive material is heated to a predetermined temperature or to within a predetermined temperature range. Alternatively, an electronic valve mechanism that can be specifically set to activate at a particular temperature or temperature range can be used in place of a mechanical valve mechanism that is actuated by a thermal motor as described above.

A return spring 48 of valve mechanism 42(1) has a first or upper end 49 attached to a first or lower end 50 of cylinder 46 (FIG. 4) and a second or upper end 51 that is attached or otherwise fixed at the bottom, closed end 52 of the first bore extension 18. When the valve mechanism 42(1) is activated, the piston 47 extends axially and upwardly out of the cylinder 46 thereby moving the cylinder 46 and valve disk 44 in a first, axial direction (i.e. downwardly) towards valve seat 34, the cylinder 46 thereby acting against return spring 48 causing it to compress. Return spring 48, therefore, serves to urge the valve mechanism 42(1) back to its first or neutral position when the thermally sensitive material returns to its original state.

An override spring 54 is arranged on cylinder 46 and has a first or upper end 55 secured or attached to the second or upper end 56 of the cylinder 46 and a second end 57 that is secured or in engagement with valve disk 44. The override spring 54 serves to urge or bias the valve disk 44 towards valve seat 34 but also allows the valve disk 44 to be moved or urged away from the valve seat 34 under certain operating conditions, e.g. in the event that pressure within the by-pass valve 10 increases beyond a certain level. The valve disk 44 may be rigidly secured to the cylinder 46 or may be slidable along the outer surface of cylinder 46, in the manner of the valves disclosed in U.S. Pat. No. 6,253,837, which is incorporated herein by reference in its entirety.

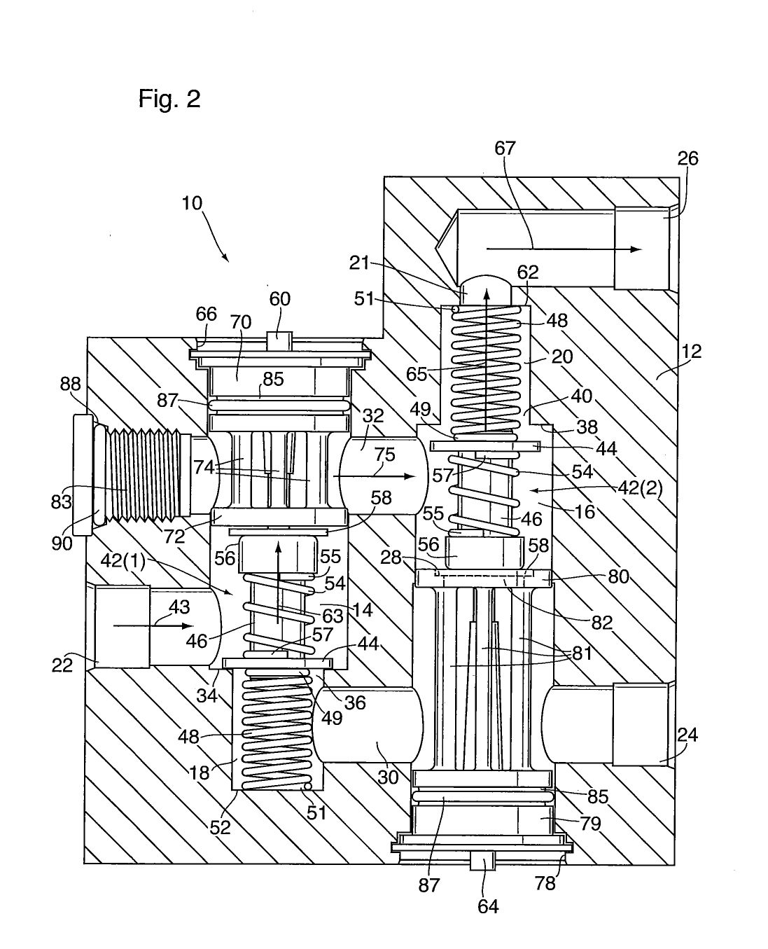

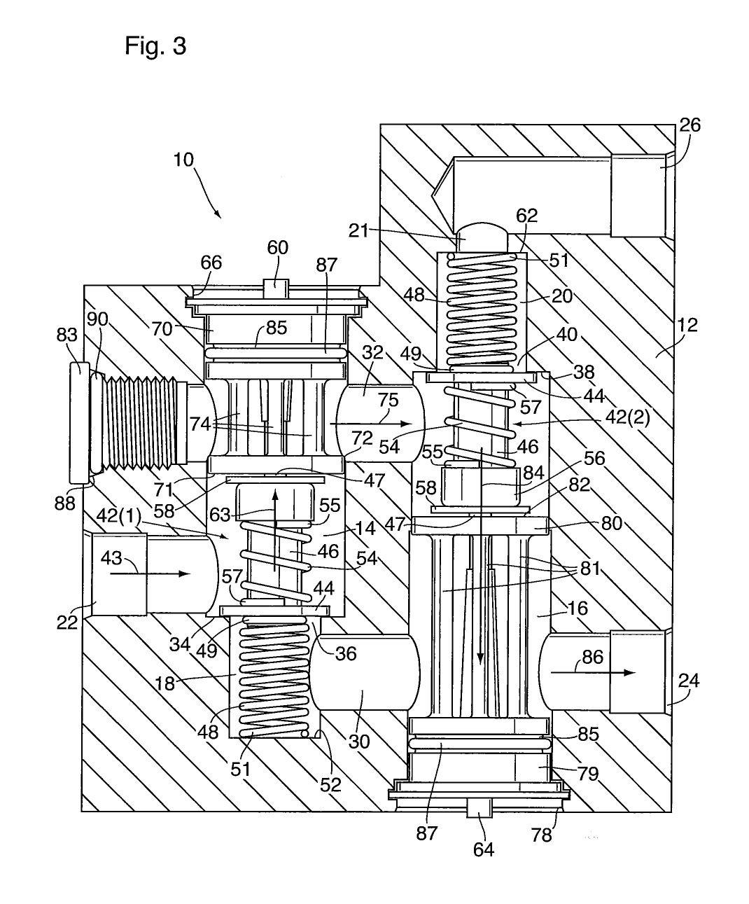

A washer or second valve disk 58 is arranged and secured at the top of the second end 56 of the cylinder 46 of the valve actuator 42(1) for movement with the cylinder 46, the second valve disk 58 serving to seal against an opening in corresponding valve closure cap 60 (also referred to herein as “first valve closure cap 60”) arranged within the first bore 14 as will be described in further detail below, and as shown most clearly in FIGS. 2 and 3.

A second temperature responsive valve actuator or valve mechanism 42(2) having the same general structure as the previously described first temperature responsive valve mechanism 42(1) is arranged inside second bore 16 and is generally oppositely disposed with respect to the first valve actuator or mechanism 42(1). Therefore, the first valve mechanism 42(1) is arranged in a first axial direction while the second valve mechanism 42(2) is arranged so as to be oriented in a second axial direction.

The second valve mechanism 42(2) is similar in structure to the first valve mechanism 42(1) and, therefore, is also operably coupled to a valve disk 44 so as to move the valve disk 44 towards and away from the valve seat 38 found at the transition or junction between the second bore 16 and the second bore extension 20 thereby closing and opening second valve opening 40. The second valve mechanism 42(2) is also provided with a return spring 48 that has a first or lower end 49 attached to one end 50 of the cylinder 46 (FIG. 4) of the second valve mechanism 42(2) and a second or upper end 51 that is attached or otherwise fixed at the opposed end 62 of the second bore extension 20. It will be understood that the opposed end 62 of the second bore extension 20 is an open, annular end with a central opening from which extension bore 21 extends.

Similar to the function of the first valve mechanism 42(1), when the second valve mechanism 42(2) is activated, the piston 47 extends axially and downwardly out of the cylinder 46 thereby moving the cylinder 46 and attached valve disk 44 in the second axial direction (i.e. upwardly), which is generally opposite to the first axial direction, towards valve seat 38 thereby against return spring 48, causing the return spring 48 to compress in a similar manner as described in respect to the first valve mechanism 42(1).

The second valve mechanism 42(2) also comprises an override spring 54 arranged on the cylinder 46 of the second valve actuator 42(2), the override spring 54 having a first or lower end 55 secured or attached to the second or lower end 56 of the cylinder 46 and a second or upper end 57 that is secured or in engagement with valve disk 44. Accordingly, as in the case of the first valve mechanism 42(1), the override spring 54 of the second valve actuator 42(2) serves to urge or bias the valve disk 44 upwardly towards valve seat 38 but also allows the valve disk 44 to be moved or urged away from the corresponding valve seat 38 under certain operating conditions, e.g. in the event that pressure within the by-pass valve 10 increases beyond a certain level.

A washer or second valve disk 58 is also arranged and secured at the bottom or the second end 56 of the cylinder 46 of the second valve mechanism 42(2) for movement with the cylinder 46, the second valve disk 58 serving to seal against an opening in corresponding valve closure cap 64 (also referred to herein as the “second valve closure cap 64”) associated with the second bore 16, as shown in FIGS. 2 and 3, as will be described in further detail below.

As can be seen from FIG. 4, the first and second valve mechanisms 42(1) and 42(2) may be identical.

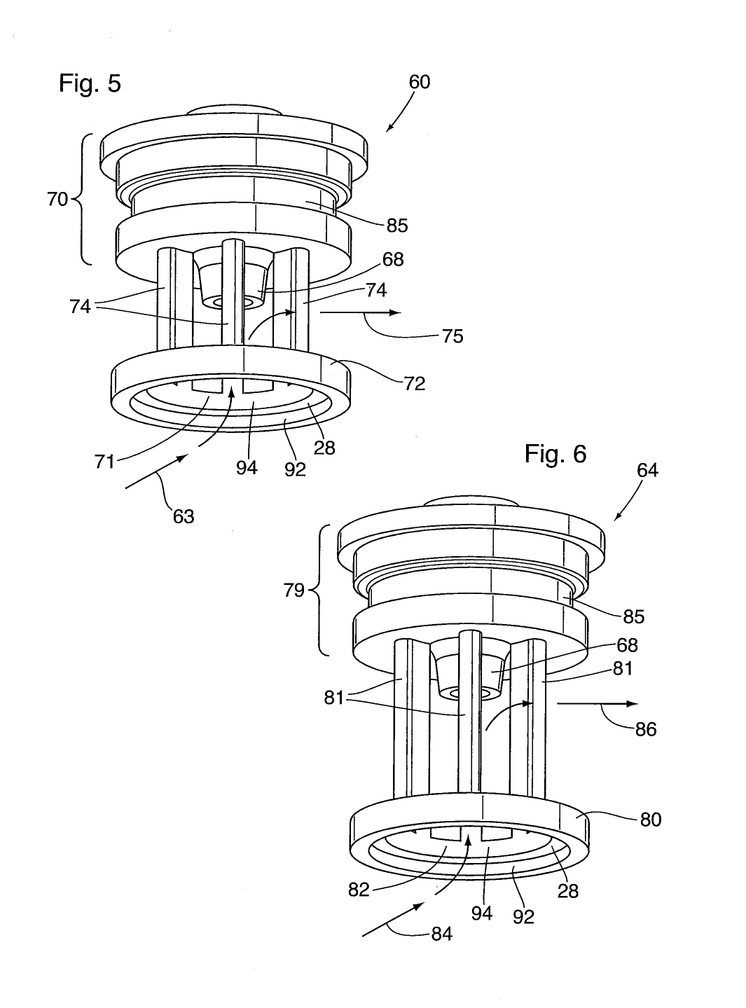

First bore 14 includes an opening 66 formed in the main body 12 that opposes valve opening 36 and through which the valve assembly or first valve mechanism 42(1) can be inserted into the first bore 14 during assembly of the by-pass valve 10. As set out above, the first valve closure cap 60 is inserted into the opening 66 to seal the first bore 14 after the first valve mechanism 42(1) is arranged in place, or alternatively the first valve closure cap 60 may be pre-assembled with the first valve mechanism 42(1) by inserting the piston 47 of first valve mechanism 42(1) into the hollow interior of a central sleeve portion 68 of the first closure cap 60, and this subassembly may then be inserted into the main body 12 through opening 66. The cap 60 can be formed from a mouldable plastic material or any suitable material in accordance with principles known in the art. The closure cap 60 can in some versions be formed from steel or other metals. The first valve closure cap 60 is shown in isolation in FIG. 5.

As shown in FIG. 2, first valve closure cap 60 defines part of the flow path interconnecting the first bore 14 and the second branch port 32 as indicated in part by flow directional arrow 63. More specifically, the cap 60 includes an upper cylindrical plug portion 70 and a spaced apart disc-like annular end portion 72 defining a central opening 71 that are joined together by a series of spaced apart vanes or struts 74. Accordingly, fluid entering the first bore 14 can pass through the central opening 71 of the disc-like annular end portion 72 of the cap 60 and through the open spaces formed between the spaced apart struts 74 as illustrated by flow directional arrow 75 (see for instance FIGS. 2 and 3).

In the illustrated embodiment, the central opening 71 of first valve closure cap 60 has a stepped bore with a first diameter 92 (FIG. 5) sufficient to receive the second valve disk 58 and a second diameter 94 (FIG. 5) which is smaller than the diameter of disk 58, with an inwardly extending annular shoulder 28 (FIG. 5) extending between the first and second diameters 92, 94. When the central opening 71 is sealed by the second valve disk 58, the valve disk 58 is in sealed engagement with the annular shoulder 28 and is at least partially recessed inside the first bore of the central opening 71. It will be appreciated that this specific arrangement for sealing central opening 71 is not essential, however, and that the disk 58 may seal against the bottom (outer) surface of the annular end portion 72 of cap 60, such that the disk 58 is not recessed inside the cap 60.

Similarly, the second bore 16 includes an opening 78 that opposes the valve opening 40 and through which the second valve mechanism 42(2) can be inserted into the second bore 16 during assembly of the by-pass valve 10. The second valve closure cap 64 is inserted into the opening 78 to seal the second bore 16 after the second valve mechanism 42(2) is arranged in position within the second bore 16, or alternatively the second valve closure cap 64 may be pre-assembled with the second valve mechanism 42(2) by inserting the piston 47 of second valve mechanism 42(2) into the hollow interior of a central sleeve portion 68 of the second closure cap 64, and this subassembly may then be inserted into the main body 12 through opening 78. The second valve closure cap 64 is shown in isolation in FIG. 6, and is similar in structure to the first valve closure cap 60 used for sealing the first bore 14 in that it also has an cylindrical plug portion 79 and a spaced apart disc-like annular end portion 80 defining a central opening 82, the cylindrical plug portion 79 and annular end portion 80 being joined together by a series of spaced apart vanes or struts 81. In the subject exemplary embodiment illustrated in FIGS. 1-3, the struts 81 of the second valve closure cap 64 extend longer than the struts 74 of the first valve closure cap 60, the second valve closure cap 64 therefore being longer than the first valve closure cap 60 and extending farther into the second bore 16. In the subject exemplary embodiment the longer second valve closure cap 64 ensures the parallel arrangement of the first and second branch ports 30, 32. As with the first valve closure cap 60, fluid entering the second bore 16 can pass through the central opening 82 of the disc-like annular end portion 80 of the second valve closure cap 64 and through the spaces or gaps formed between spaced apart struts 81 as illustrated by flow directional arrows 84, 86 shown in FIG. 3.

In the illustrated embodiment, the central opening 82 of second valve closure cap 64 has a stepped bore with a first diameter sufficient to receive the second valve disk 58 and a second diameter which is smaller than the diameter of disk 58, with an inwardly extending annular shoulder 28 (FIG. 6) extending between the first and second diameters. When the central opening 82 is sealed by the second valve disk 58, the valve disk 58 is in sealed engagement with the annular shoulder 28 and is at least partially recessed inside the first bore of the central opening 82. It will be appreciated that this specific arrangement for sealing central opening 82 is not essential, however, and that the disk 58 may seal against the bottom (outer) surface of the annular end portion 80 of cap 64, such that the disk 58 is not recessed inside the cap 64.

Both valve closure caps 60, 64 may further comprise a groove 85 formed in their respective cylindrical plug portions 70, 79 for receiving a suitable sealing device or O-ring 87 for ensuring a fluid tight seal is created between the walls of the respective openings 66, 78 and the valve closure caps 60, 64 when the caps 60, 64 are inserted into the main body portion 12 of the valve 10.

Additional sealing plugs 83 can be used to close or seal any additional openings or unused ports that may be formed in the main body 12 of the valve 10. For instance, for ease of manufacturing, the second branch port 32 that interconnects the first bore 14 and the second bore 18 may be formed by a port or opening 88 formed in a surface of the main body 12 and extending through the main body 12 to the first bore 14 and through the first bore 14 to the second bore 16. The portion of the port 88 that extends from the outer surface of the main body 12 to the first bore 14 is essentially unused and can be sealed or closed off by any suitable sealing plug 83 or any other suitable means for sealing the opening 88, and may include an O-ring 90.

During assembly of the valve 10, the first and second valve mechanisms 42(1), 42(2) are selected so that the second valve mechanism 42(2) operates or is activated at a different thermal range than the first valve mechanism 42(1). This can be achieved based on the thermal properties of the particular thermal material that is housed within the cylinder 46 of the each of the valve mechanisms 42(1), 42(2). Alternatively, as mentioned above, electronically controlled valves that can be set to different activation temperatures may be used.

In operation, when a control fluid enters the valve 10 through inlet port 22 and flows into the first bore 14, the first valve mechanism 42(1) is in its first or neutral position with the second valve disc 58 sealing against the annular end portion 72 of first valve closure cap 60 and with the first valve disk 44 being spaced away from the valve seat 34 as illustrated in FIG. 1. Accordingly, when the first valve mechanism 42(1) is in its first or neutral position, the valve opening 36 and first bore extension 18 associated with first valve mechanism 42(1) are open and in fluid communication with the first bore 14. Therefore, fluid entering the first bore 14 flows past the open valve disk 44 through opening 36 into the first bore extension 18 as illustrated by flow directional arrows 43, 45 in FIG. 1. From the first bore extension 18, the fluid travels through the first branch port 30 to the second bore 16 as illustrated by flow directional arrow 53: Due to the opposite arrangement of the first and second valve mechanisms 42(1), 42(2) in their respective bores 14, 16, the first branch port 30 interconnects the first bore 14 and the second bore 16 at the end of the second bore 16 (lower end) that is remote from the thermal actuator associated with the second valve mechanism 42(2). Accordingly, fluid entering the second bore 16 via the first branch port 30 does not come into direct contact with second valve mechanism 42(2). Instead, the control fluid entering the second bore 16 from the first bore 14 via first branch port 30 passes through the open passages formed between the struts 81 of the second valve closure cap 64 (see flow directional arrow 53 in FIG. 1) and is discharged from the valve 10 through the first outlet port 24 where it can be directed to the appropriate downstream component that forms part of the overall system, e.g. a heat exchanger 13 (see for instance FIG. 7).

Therefore, by-pass valve 10 has a first operational state, as illustrated in FIG. 1, wherein the first and second valve mechanisms 42(1), 42(2) are in their respective first or neutral positions with the second valve disk 58 of each mechanism 42(1), 42(2) sealing against the corresponding annular end portion 72, 80 of the corresponding valve closure cap 60, 64, and with the valve disk 44 of each valve mechanism 42(1), 42(2) being spaced apart from the corresponding annular valve seat 36, 38, with the control fluid entering the valve 10 having a temperature that is within a first predetermined range, for instance, below 90 degrees Celsius.

Accordingly, when the control fluid entering the valve 10 is within the first predetermined temperature range, e.g. below 90 degrees Celsius, as sensed by the first valve mechanism 42(1), the first valve mechanism 42(1) remains open (or in its first, neutral position) allowing the control fluid to pass through valve opening 36, through the first branch port 30 to the second bore 16 where it is discharged through first outlet port 24 and can be directed to an appropriate system component that forms part of the overall fluid or heat exchange circuit.

In the case of an automobile for example, it may be beneficial to direct a system fluid (such as engine oil, transmission fluid, axle oil, exhaust gas, etc.) to a heat exchanger for warming and/or cooling depending on the particular temperature of the system fluid during operation of the vehicle and to by-pass the heat exchanger at other operating conditions so as to avoid pressure losses in the overall system when the warming and/or cooling function of the heat exchanger is not required. In the case of an automobile at cold start conditions, for example, a number of system fluids may require warming in order to bring the temperature of the system fluid to its optimal operating temperature as quickly as possible. In such circumstances, valve 10 can be incorporated into the automobile system at a location intermediate the fluid source 11 (e.g. the engine, transmission, etc.) and a corresponding heat exchanger 13 (e.g. engine oil cooler (EOC), transmission oil cooler (TOC), exhaust gas heat recovery (EGHR), etc.) as illustrated in FIG. 7 so as to direct the control fluid exiting the valve 10 to the heat exchanger for warming when the temperature of the control fluid is within the first predetermined range. The by-pass valve 10 can also be used to by-pass the heat exchanger 13 at other operating conditions and to re-direct the control fluid to the heat exchanger under other operating conditions as will be described below.

As the temperature of the control fluid entering the valve 10 increases to within a second predetermined range, for instance to a temperature above 100 degrees Celsius and below 120 degrees Celsius, the control fluid entering the first bore 14 through inlet port 22 comes into contact with the first valve mechanism 42(1) causing the thermal material housed within cylinder 46 of the first valve mechanism 42(1) to expand thereby activating the first valve mechanism 42(1) causing valve disk 44 to seal against annular valve seat 34 thereby blocking or closing valve opening 36. This causes the second valve disk 58 that was originally pressed against the annular end portion 72 of the first valve closure cap 60 to move away from the first valve closure cap 60 thereby opening and/or exposing the central opening 71 of the annular end portion 72 of the first valve closure cap 60. Accordingly, the control fluid entering the first bore 14 can pass through the central opening 71 of the annular end portion 72 of the first valve closure cap 60 and through the gaps or spaces formed between the struts 74 into the second branch port 32 as illustrated in FIG. 2. From the second branch port 32 the fluid is transferred or flows into the second bore 16 in the direction of arrow 75, coming into contact with the second valve mechanism 42(2). Since the second valve mechanism 42(2) is selected or specifically set to operate/activate at a different, higher temperature than the first valve mechanism 42(1), when the temperature of the control fluid entering the second bore 16 is within the second predetermined range (e.g. a temperature above 100 degrees Celsius and below 120 degrees Celsius), the second valve mechanism 42(2) remains in its first or neutral position with its valve disk 44 spaced away from the corresponding valve seat 38 and with the second valve disk 58 pressed or sealed against the annular end portion 80 of the corresponding second valve closure cap 64 as illustrated in FIG. 2. Accordingly, the second valve disk or washer 58 prevents fluid from flowing through the central opening 82 formed in the annular end portion 80 of the second valve closure cap 64 and through the spaces or gaps formed between the struts 81 while the first valve disk 44 allows the control fluid entering the second bore 16 via second branch port 32 to flow from the second bore 16 through valve opening 40 where it is discharged from the valve 10 via second outlet port 26, as illustrated by flow directional arrows 65, 67 in FIG. 2, effectively by-passing the heat exchanger 13 (or other system component) arranged in fluid communication with first outlet port 24 of the valve 10 where it can be directed elsewhere within the overall system or returned to the fluid source 11.

As the temperature of the control fluid entering the valve 10 continues to increase (e.g. during regular operation of the automobile) to a third predetermined temperature range, for instance to a temperature greater than 130 degrees Celsius, the second valve mechanism 42(2) begins to activate as the thermal material housed within the corresponding cylinder 46 of the second valve mechanism 42(2) expands at this temperature causing the valve disk 44 to be brought into sealing contact with annular valve seat 38, effectively closing or blocking valve opening 40. Therefore, fluid entering the valve 10 at a temperature greater than 130 degrees Celsius, for example, flows into the first bore 14, through the central opening 71 of the first valve closure cap 60 to the second branch port 32, since the first valve opening 36 is blocked by valve disk 44, the first valve mechanism 42(1) having already been activated. From the second branch port 32, the fluid enters the second bore 16 where it is brought into contact with the second valve mechanism 42(2), the thermal material in the second valve mechanism 42(2) expanding now that the temperature of the control fluid is within the third predetermined range, thereby activating the second valve mechanism 42(2) and bringing it into its second or closed position, as illustrated in FIG. 3. As the second valve mechanism 42(2) activates, the valve disk 44 is brought into contact with and seals against the second peripheral valve seat 38, effectively sealing or closing second valve opening 40 while the second valve disk or washer 58 is now spaced apart from the annular portion 80 of the second valve closure cap 64. Accordingly, the fluid entering the second bore 16 from the second branch port 32 flows through the central opening 82 of the annular end portion 80 of the second valve closure cap 64 and through the gaps or spaces formed between the struts 81 where it is discharged from the valve 10, once again, through the first outlet port 24 where it can be directed to the heat exchanger 13 for cooling, for example. Accordingly, a single control fluid at two different temperature ranges can be directed to the same fluid outlet port, e.g. first outlet port 24, of the main body 12 of the valve 10 to a connected component, e.g. heat exchanger 13, while the control fluid can be directed through a different fluid outlet port, e.g. second outlet port 26 when it is at a different temperature range.

While an exemplary embodiment of the by-pass valve has been described, it will be understood by persons skilled in the art that certain adaptations and modifications of the described embodiment can be made. Therefore, the above discussed embodiment is considered to be illustrative and not restrictive.

What is claimed is:

1. A by-pass valve, comprising:
a main body;
a first bore formed in said main body, the first bore having a first end and a second end;
a second bore formed in said main body that is spaced apart from and extends generally parallel to said first bore, the second bore having a first end and a second end;
a fluid inlet in fluid communication with said first bore;
a first fluid outlet in communication with the first end of said second bore;
a second fluid outlet in communication with the second end of said second bore;
a first branch port fluidly interconnecting said first bore and said first end of said second bore;
a second branch port fluidly interconnecting said first bore and said second end of said second bore;
a first valve mechanism arranged in said first bore for controlling flow to either said first branch port or said second branch port; and
a second valve mechanism arranged in said second bore for controlling flow from either said first branch port or said second branch port to either said first outlet or said second outlet;
wherein said first valve mechanism activates at a first predetermined activation temperature and said second valve mechanism activates at a second predetermined activation temperature.

2. A by-pass valve as claimed in claim 1, wherein the first branch port fluidly interconnects said second end of said first bore and said first end of said second bore; and wherein the second branch port fluidly interconnects said first end of said first bore and said second end of said second bore.

3. A by-pass valve as claimed in claim 1, wherein said first valve mechanism is operable between a first position wherein said first bore is in fluid communication with said first branch port, and a second position wherein said first bore is in fluid communication with said second branch port; and
said second valve mechanism is operable between a first position establishing fluid communication between either said first branch port and said first fluid outlet via said second bore, or said second branch port and said second fluid outlet via said second bore, and a second position establishing fluid communication between said second branch port and only said first fluid outlet.

4. A by-pass valve as claimed in claim 3, wherein said second branch port is fluidly isolated from said fluid inlet when said first valve mechanism is in said first position; and
wherein said first end of said second bore is fluidly isolated from said second end of said second bore when said second valve is in said first position.

5. A by-pass valve as claimed in claim 3, comprising:
a first operational state wherein said first valve mechanism is in said first position and said second valve mechanism is in said first position, said fluid inlet being in fluid communication with said first fluid outlet through the second end of the first bore, the first branch port and the first end of the second bore;
a second operational state wherein said first valve mechanism is in said second position and said second valve mechanism is in said first position, said fluid inlet being in fluid communication with said second fluid outlet through the first end of the first bore, the second branch port and the second end of the second bore; and
a third operational state wherein said first valve mechanism is in said second position and said second valve mechanism is in said second position, said fluid inlet being in fluid communication with said first fluid outlet through the first end of the first bore, the second branch port and the first end of the second bore.

6. A by-pass valve as claimed in claim 1, wherein said first activation temperature is approximately less than or equal to 90° C. and wherein said second activation temperature is approximately greater than or equal to 120° C.

7. A by-pass valve as claimed in claim 1, wherein said first and second branch ports extend generally perpendicular to said first and second bores, said first and second branch ports being spaced apart from and generally parallel to each other.

8. A by-pass valve as claimed in claim 1, further comprising:
a first bore extension serially communicating with said first bore and substantially aligned with said first bore along a central axis of the first bore;
a second bore extension serially communicating with said second bore and substantially aligned with said second bore along a central axis of the second bore;
a first valve seat facing said first bore at a juncture between the first bore and the first bore extension; and
a second valve seat facing said second bore at a juncture between the second bore and the second bore extension;
wherein said first branch port extends from said first bore extension, fluidly interconnecting said first bore and said second bore, and said second fluid outlet communicates with said second extension bore.

9. A by-pass valve as claimed in claim 8, wherein said first valve mechanism acts against said first valve seat fluidly isolating said first bore extension and said first branch port from said first bore at said first activation temperature; and
wherein said second valve mechanism acts against said second valve seat fluidly isolating said second extension bore and said second fluid outlet from said second bore.

10. A by-pass valve as claimed in claim 8, wherein said first extension bore and said second extension bore each have a cross-sectional flow area that is smaller than said first and second bores, respectively; and
wherein said first and second extension bores are oppositely disposed with respect to each other, said first extension bore extending from said second end of said first bore and said second extension bore extending from said second end of said second bore.

11. A by-pass valve as claimed in claim 1, further comprising a first valve closure cap arranged in said first bore forming a fluid tight seal with said main body, said first valve mechanism cooperating with said valve closure cap for controlling flow from said first bore to said second branch port; and
a second valve closure cap arranged in said second bore and forming a fluid tight seal with said main body portion, said second valve mechanism cooperating with said second valve closure cap for controlling flow from said second branch port to said first fluid outlet.

12. A by-pass valve as claimed in claim 11, wherein each of said valve closure caps comprises:
a cylinder plug end for forming a fluid tight seal with said main body;
an open, annular end for cooperating with the respective first or second valve mechanism; and
a series of struts interconnecting said cylinder plug end and said open, annular end and forming fluid passages therebetween.

13. A by-pass valve as claimed in claim 12, wherein the struts of said second valve closure cap are longer than the struts of said first valve closure cap, the second valve closure cap having a greater overall length than said first valve closure cap.

14. A by-pass valve as claimed in claim 1, wherein said first and second valve mechanisms are one of the following alternatives: mechanical valves or electronic valves.

15. A by-pass valve as claimed in claim 1, wherein said first and second valve mechanisms are mechanical valves that each comprise:
a cylinder portion housing a thermally sensitive material;
a piston slidingly connected to said cylinder for movement in response to expansion and/or contraction of said thermal sensitive material;
a first valve disk connected to a first end of said cylinder for cooperating with a corresponding valve seat; and
a second valve disk connected to an opposed, second of said cylinder.

16. A by-pass valve as claimed in claim 5, wherein said first fluid outlet is connected to an inlet of a heat exchanger, said by-pass valve directing a control fluid to said heat exchanger in said first and third operational states, and wherein in said second fluid outlet is connect to a fluid return line for directing said control fluid away from said heat exchanger in said second operational state.
